(19) United States
(12) Patent Application Publication
(10) Pub. No.: US 2007/0274708 A1
(43) Pub. Date: Nov. 29, 2007

(54) Buffer structure

(76) Inventors: Feng Chang, Hsinchu (TW); Chih-Shen Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/521,366

(22) Filed: Sep. 15, 2006

(30) Foreign Application Priority Data
May 24, 2006 (TW) 95208996

(51) Int. Cl. G03B 17/00

(52) U.S. Cl. 396/439; 396/542

(57) ABSTRACT

A buffer structure for reducing external forces to be transmitted from a PCB to a lens module via a support element is disclosed. The buffer structure comprises a plurality of first and second buffer units. In addition, the lens module is fixed on a first one side of the support element via the first buffer units, and a second one side of the support element is fixed on the PCB via the second buffer units. Thereby, each first buffer unit generate a first buffer effect between the lens module and the support element, and each second buffer unit generate a second buffer effect between the PCB and a combination of the lens module and the support element.

### BACKGROUND OF THE INVENTION

1. Field of The Invention

The present invention relates to a buffer structure, and particularly relates to a buffer structure for reducing external forces to be transmitted from a PCB to a lens module via a support element.

2. Description of the Related Art

In order to fasten the camera lens module's stand, including the module of camera lens, with the main board, ordinary digital camera cell phones, traditional cameras, digital cameras and digital video cameras employ the way of soldering or screwing to achieve such objective.

Nevertheless, when the whole camera module is crashed or shocked by external forces, these forces will be carried to the camera lens module via circuit board. Although soldering or screwing may be a quick and reliable way to fasten the camera lens with the main board in production and assembly, however, the camera lens module ought to bear these external forces carried through circuit board. Therefore, the camera lens module would easily been damaged.

### SUMMARY OF THE INVENTION

The present invention provides a buffer structure for reducing external forces to be transmitted from a PCB to a lens module via a support element. The buffer structure is disposed between a lens module seat of a lens module and a PCB, and the buffer structure that can be a combination of a sleeve post and a sleeve seat and is made of buffer material such as rubber, silicone or plastic. Hence, the present invention can use the combination of the sleeve post and the sleeve seat replaces a join way of welding or screwing. Therefore, the buffer structure not only can be used to fix the lens module on the PCB, but also when a whole camera module is crashed or shocked by external forces, these forces will be absorbed via the buffer structure for reducing the damage of the lens module.

A first aspect of the present invention is a buffer structure for reducing external forces to be transmitted from a PCB to a lens module via a support element. The buffer structure comprises a plurality of first and second buffer units. In addition, the lens module is fixed on a first one side of the support element via the first buffer units, and a second one side of the support element is fixed on the PCB via the second buffer units. Thereby, each first buffer unit generate a first buffer effect between the lens module and the support element, and each second buffer unit generate a second buffer effect between the PCB and a combination of the lens module and the support element.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, exposed view of a buffer structure according to the present invention; and

FIG. 2 is a perspective, assembled view of a buffer structure according to the present invention.

### DETAILED DESCRIPTION OF PREFERRED BEST MOLDS

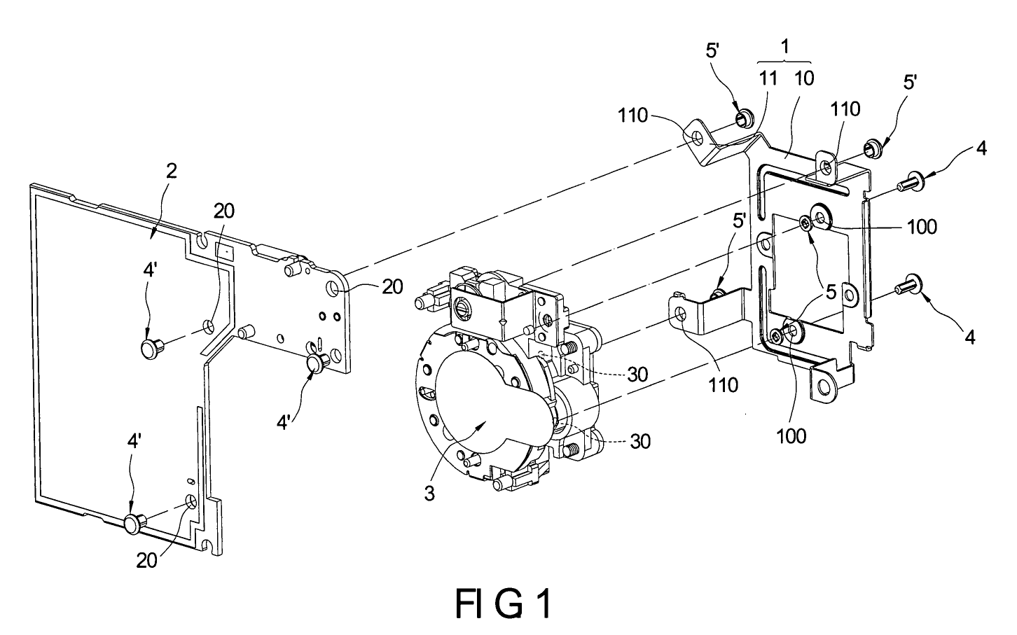

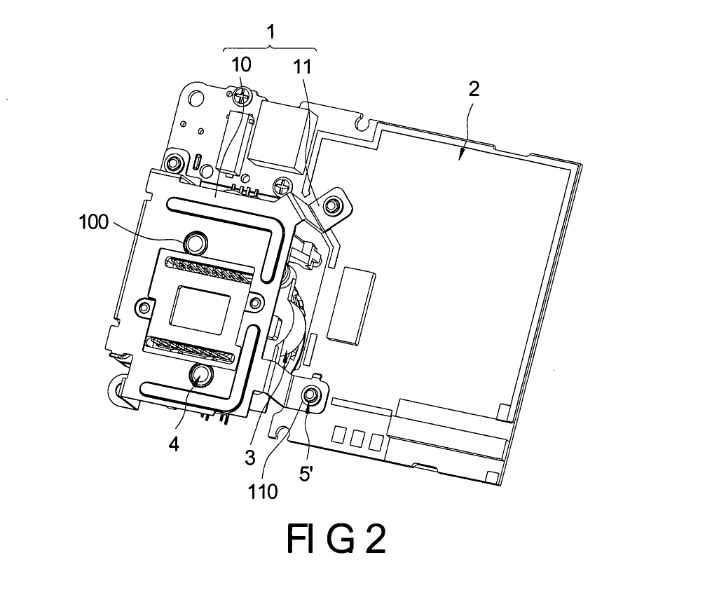

Referring to FIGS. 1-2, the present invention provides a buffer structure for reducing external forces to be transmitted from a PCB 2 to a lens module 3 via a support element 1. The buffer structure comprises a plurality of first and second buffer units. In addition, the lens module 3 is fixed on a first one side of the support element 1 via the first buffer units, and a second one side of the support element 1 is fixed on the PCB 2 via the second buffer units.

Moreover, the support element 1 can be made of rigid buffer material, and the support element 1 has a receiving platform 10 formed on the first one side thereof, and a plurality of position pins 11 outwardly extended from the receiving platform 10 and disposed on the second one side thereof. Hence, the lens module 3 can be disposed on the receiving platform 10 of the support element 1, and the position pins 11 of the support element 1 can be fixed on the PCB 2. In other words, the support element 1 is fixed on the PCB 2 via the position pins 11. However, the shape description of the support element 1 does not use to limit the present invention. The support element 1 with any shape for fixing the lens module 3 on the PCB 2 is protected in the present invention.

Furthermore, each first buffer unit includes a first fixed element 4 with a shock absorbing function, and the first fixed element 4 can be a screw with the shock absorbing function. Moreover, the lens module 3 has a plurality of screw holes 30, and the receiving platform 10 has a plurality of first through holes 100 corresponding to the screw holes 30. Hence, the first fixed elements 4 are respectively passed through the first through holes 100 and screwed into the screw holes 30 for fixing the lens module 3 on the receiving platform 10 of the support element 1.

In addition, each first buffer unit further comprises a plurality of buffer elements 5 with a shock absorbing function, and each buffer element 5 is disposed between the lens module 3 and the support element 1 for mating with the corresponding first fixed element 4. Furthermore, the buffer element 5 can be a washer with the shock absorbing function. Hence, referring to the embodiment of FIG. 1, the first fixed elements 4 (the screws) are respectively passed through the first through holes 100 and the buffer elements 5 (the washers), and screwed into the screw holes 30. Therefore, each match of one first fixed element 4 (the screw) and one buffer element 5 (the washer) generate a buffer effect between the lens module 3 and the support element 1.

Moreover, each second buffer unit includes a pair of a second and a third fixed element 4′, 5′ with a shock absorbing function, and the second and the third fixed element 4′, 5′ are mated each other. In addition, each position pin 11 has a second through hole 110 and the PCB 2 has a plurality of third through holes 20 corresponding to the second through holes 110. Therefore, the second fixed elements 4′ are respectively passed through the second and the third through holes 110, 20 and mated with the third fixed elements 5′ for fixing the support element 1 on the PCB 2.

Referring to the embodiment of FIG. 1, the second fixed element 4′ can be a sleeve post, and the third fixed element 5′ can be a sleeve seat mated with the corresponding sleeve post each other. Hence, the second fixed elements 4′ (the sleeve post) are respectively passed through the second and the third through holes 110, 20 and tightly received into the third fixed elements 5′ (the sleeve seat) for tightly fixing the support element 1 on the PCB 2.

According to different needs, the second fixed element 4′ can be a screw, and the third fixed element 5′ can be a nut mated with the corresponding screw each other. In other words, according to another need, the second fixed element 4′ can be designed to be a screw and the third fixed element 5′ can be designed to be a nut. The match of the screw and the nut can finish above-mentioned fixed action. In other words, according to different needs, a designer can choose any two fixed elements with shock absorbing or buffer function that are mated each other. In addition, if an inner thread is formed on a surface of the third through hole 20, the second buffer unit is a screw. Hence the support element 1 can be fixed on the PCB 2 via the screws only. However, above-mentioned fixed methods do not use to limit the present invention. All of the ways of fixing the lens module 3 on the support element 1 and fixing the support element 1 on the PCB 2 are protected in the present invention.

In conclusion, each first buffer unit (the match of the first fixed element 4 and the buffer element 5) generate a first buffer effect between the lens module 3 and the support element 1, and each second buffer unit (the match of the second fixed element 4′ and the third fixed element 5′) generate a second buffer effect between the PCB 2 and a combination of the lens module 3 and the support element 1.

Furthermore, the buffer structure of the present invention is disposed between a lens module seat (not label) of the lens module 3 and the PCB 2, and the buffer structure that can be a combination of a sleeve post and a sleeve seat and is made of buffer material such as rubber, silicone or plastic. Hence, the present invention can use the combination of the sleeve post and the sleeve seat replaces a join way of welding or screwing. Therefore, the buffer structure not only can be used to fix the lens module 3 on the PCB 2, but also when a whole camera module (not shown) is crashed or shocked by external forces, these forces will be absorbed via the buffer structure for reducing the damage of the lens module 3.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A buffer structure for reducing external forces to be transmitted from a PCB to a lens module via a support element, and the buffer structure comprising a plurality of first and second buffer units, wherein the lens module is fixed on a first one side of the support element via the first buffer units, and a second one side of the support element is fixed on the PCB via the second buffer units;
whereby, each first buffer unit generate a first buffer effect between the lens module and the support element, and each second buffer unit generate a second buffer effect between the PCB and a combination of the lens module and the support element.

2. The buffer structure as claimed in claim 1, wherein the support element is made of rigid buffer material.

3. The buffer structure as claimed in claim 1, wherein the support element has a receiving platform formed on the first one side thereof, and a plurality of position pins outwardly extended from the receiving platform and disposed on the second one side thereof.

4. The buffer structure as claimed in claim 3, wherein the lens module is disposed on the receiving platform of the support element, and the support element is fixed on the PCB via the position pins.

5. The buffer structure as claimed in claim 1, wherein each first buffer unit includes a first fixed element with a shock absorbing function.

6. The buffer structure as claimed in claim 5, wherein the first fixed element is a screw.

7. The buffer structure as claimed in claim 5, wherein the lens module has a plurality of screw holes and the receiving platform has a plurality of first through holes corresponding to the screw holes, wherein the first fixed elements are respectively passed through the first through holes and screwed into the screw holes for fixing the lens module on the receiving platform of the support element.

8. The buffer structure as claimed in claim 5, wherein each first buffer unit further comprises a plurality of buffer elements with a shock absorbing function, and each buffer element is disposed between the lens module and the support element for mating with the corresponding first fixed element.

9. The buffer structure as claimed in claim 8, wherein the buffer element is a washer.

10. The buffer structure as claimed in claim 1, wherein each second buffer unit includes a pair of a second and a third fixed element with a shock absorbing function, and the second and the third fixed element are mated each other.

11. The buffer structure as claimed in claim 10, wherein each position pin has a second through hole and the PCB has a plurality of third through holes corresponding to the second through holes, wherein the second fixed elements are respectively passed through the second and the third through holes and mated with the third fixed elements for fixing the support element on the PCB.

12. The buffer structure as claimed in claim 10, wherein the second fixed element is a sleeve post, and the third fixed element is a sleeve seat mated with the corresponding sleeve post each other.

13. The buffer structure as claimed in claim 10, wherein the second fixed element is a screw, and the third fixed element is a nut mated with the corresponding screw each other.
